(19) United States
(12) Patent Application Publication
(10) Pub. No.: US 2025/0221510 A1
(43) Pub. Date: Jul. 10, 2025

(54) DEVICE, SYSTEM AND METHOD FOR DISPENSING A FLUID PRODUCT ON DEMAND, IN PARTICULAR A COSMETIC PRODUCT

(71) Applicants: LABORATOIRES CLARINS, PARIS (FR); CLARINS, NEUILLY SUR SEINE (FR)

(72) Inventors: Alex NKENGNE NGUIMEZONG, TRIEL SUR SEINE (FR); Marc BUREAU, JUVISY SUR ORGE (FR)

(21) Appl. No.: 18/852,613

(22) PCT Filed: Mar. 23, 2023
(86) PCT No.: PCT/EP2023/057533

§ 371 Date: Sep. 30, 2024

(30) Foreign Application Priority Data
Mar. 29, 2022 (FR) FR2202839

(51) Int. Cl. A45D 34/04; A45D 44/00; B01F 33/84

(52) U.S. Cl. CPC A45D 34/04; A45D 44/005; B01F 33/8442; A45D 2200/058

(57) ABSTRACT

The disclosure relates to a device for dispensing a fluid product (P) on demand, in particular a cosmetic product. The device is configured to allow mixing of at least two products, referred to as base products, in proportions selected from information originating from a user, in order to form the product on demand. The device comprises a mixer configured to mix the base products, the device being configured to supply the mixer separately with the base products in the proportions and to dispense the product (P) on demand at the outlet of the mixer, the mixer being single-use.

### CROSS-REFERENCE TO RELATED APPLICATION(S)

This present application is a national stage application of International Patent Application No. PCT/EP2023/057533, filed Mar. 23, 2023, which claims priority to French Patent Application No. 2202839, filed Mar. 29, 2022, the disclosures of which are hereby incorporated by reference in their entireties.

### TECHNICAL FIELD

This disclosure relates to a device and a method for dispensing a fluid product on demand, in particular a cosmetic product. It may in particular be a lip product such as lip oil. It also relates to a dispensing system comprising such a device.

### BACKGROUND

Devices for dispensing cosmetic products on demand enable a user to obtain a product that corresponds to her actual need rather than depending on a limited choice of products in a predefined range. Such devices make it possible to collect given proportions of basic products from containers which, after mixing, form the product

In certain known devices, the base products are dispensed separately and it is up to the user to mix them. This has disadvantages because the user does not always have the appropriate equipment to perform mixing. In addition, though such devices may be suitable for dispensing samples of small quantities of products, they are less suitable for dispensing larger doses. They therefore require the user to quickly repeat the operation to obtain a new dose of products.

Dispensing devices comprising a circuit for mixing the different base products to be used in the formulation of the product to be dispensed are also known. In addition to the advantage for the user of not having to mix the base products herself, such devices make it possible to obtain larger doses.

They do however present a challenge linked to the need for the dose dispensed not to be contaminated by residues from the previous dose, which could remain in the part of the circuit used for the mixing of the base products.

One aim of the disclosure is to propose a dispensing device, which at least partially addresses the above disadvantages.

### SUMMARY

The disclosure relates in this sense to a device for dispensing a fluid product on demand, in particular a cosmetic product, said device being configured to allow a mixture of at least two products, called base products, in proportions chosen from information coming from a user in order to form said product on demand, said device comprising a mixer, configured to ensure the mixing of said base products, said device being configured to supply said mixer separately with said base products, in said proportions, and to deliver the product on demand at the outlet of said mixer, said mixer being single-use.

“Single-use” means that the mixer 26 is intended to be changed on each new use, i.e., for each dispensing of a new dose of product on demand P, each of said doses being constituted by the mixing of the base products in quantities corresponding to said chosen proportions. “Separately” means that the device is configured so that there is no mixing of the base products upstream of the mixer, even if they can simultaneously enter said mixer.

Thanks to the use of a mixer, which is entirely interchangeable, upstream of which no mixing of base products takes place, the device according to the disclosure ensures that there are no portions of the circuit where residues from the previous dose, already mixed, may be present. This ensures that each new dose contains only the desired proportions of base products, while not reverting to a separate dispensing of said base products. In addition, it is possible to avoid having to clean the circuit between each use.

According to additional characteristics, which can be implemented independently of each other or according to all technically possible combinations and which form equally as many embodiments of the disclosure:
the mixer is a static mixer;
the mixer comprises an endless screw;
said device further comprises an injector, configured to supply the mixer with said base products;
the injector comprises an inlet opening and outlet opening for each of said base products;
the inlet and outlet openings of the injector are respectively connected by tubes for circulating the base products;
the tubes have a reduced cross-section between the inlet and the outlet;
said injector have an outlet interface and said mixer have a connection interface, intended to cooperate in order to be connected to each other;
said outlet interface has at least two pins, one of said pins having at least one of the outlets of the injector and the other or another of said pins having at least the other or another of the outlets of the injector;
said connection interface has at least two cavities, each of the cavities being configured to respectively accommodate one of said pins so that said base products lead, in particular axially, into said cavities;
said injector and said mixer are configured to allow quick connection to each other;
the device comprises a plurality of cartridges each containing one of said base products;
the cartridges remain open to the open air when in use;
said device comprises a plurality of pumps, for collecting said base products from the cartridges and for supplying said mixer with said base products, in said proportions;
the pumps are of the peristaltic type;
said device comprises a circuit connecting the cartridges to the mixer through the pumps;
said circuit comprises a hose;
said device comprises a housing having a dispensing chamber, allowing the installation of a bottle intended to receive said product on demand at the outlet of the mixer;
said chamber opens to the outside;
said chamber accommodates said mixer so that said mixer can be installed and removed at said chamber;
said injector is flush with said chamber so that said mixer can be installed and removed from said injector;
said device comprises an electronic control unit;
said control unit is configured to use data from scales to control the dispensing of the product on demand;
said control unit is configured to control the pumps;
said device comprises first scales for respectively weighing the content of each cartridge;
said device comprises a second scale for weighing the content of the bottle;
said control unit is configured to use data from the first scales and the second scale to control the pumps until said product is delivered on demand after collecting said base products in said proportions;
said control unit is configured so that the circuit is filled with base products after each dispensing of a dose of product on demand;
said base products advantageously comprise a plurality of monochromatic products accompanied by a texturising base product and a base product, called neutral.

The disclosure also relates to a dispensing system comprising a device as described above and a user interface for determining the proportions of base products to be collected to obtain the product on demand.

Said user interface comprises, for example, a smartphone and/or a tablet or a screen equipped with an application allowing a colour to be chosen for said product on demand from a palette of predefined colours corresponding to given proportions of base product.

The disclosure also relates to a method for dispensing a fluid product on demand, in particular a cosmetic product, said method comprising a step of mixing at least two products, called base products, in proportions chosen from information from a user in order to form said product on demand, said mixing step being carried out using a mixer by supplying said mixer separately with said base products, in said proportions, and to deliver the product on demand at the outlet of said mixer, said method comprising a step of installing a new mixer for each new use.

According to additional characteristics, which can be implemented independently of each other or according to all technically possible combinations and which form equally as many embodiments of the disclosure:
said method comprises a first step of weighing the base products collected to form said product on demand;
said method comprises a second step of weighing the product on demand dispensed;
said first and second weighing steps are carried out simultaneously;
said method comprises an initial step of filling a mixer supply circuit.

### BRIEF DESCRIPTION OF THE DRAWINGS

Other characteristics, details and advantages will emerge on reading the detailed description below, and on analysing the attached drawings, where:

FIG. 1 is a perspective view of an example of a dispensing device according to the disclosure,

FIG. 2 is a schematic view of an example of a dispensing device according to the disclosure,

FIG. 3 is a schematic view of an injector and a mixer of an example of a dispensing device according to the disclosure,

FIG. 4 is a perspective view of the injector of FIG. 3,

FIG. 5 is a top view of the injector of FIG. 3,

FIG. 6 is a bottom view of the injector of FIG. 3,

FIG. 7 is a schematic view of an example of a user interface of a dispensing system according to the disclosure,

FIG. 8 is a perspective view of an upper part of the mixer of FIG. 3, and

FIG. 9 is a top view of the mixer of FIG. 3.

### DETAILED DESCRIPTION

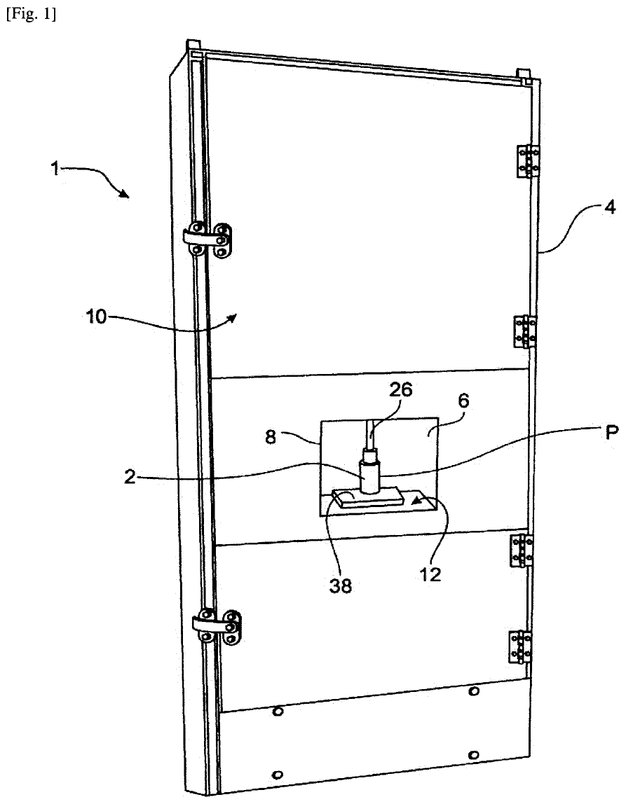

As illustrated in FIG. 1, the disclosure relates to a device 1 for dispensing a fluid product on demand P, in particular a cosmetic product.

It allows the dispensing of the product on demand P, in particular, in a bottle 2 intended to receive said product on demand P. For example, the bottle 2 is placed in the dispenser by the user, or an operator acting on her behalf, before the dispensing of the product on demand P. Once the product on demand P has been dispensed and the bottle 2 has been filled, it is removed by the user, or the operator, and it can be taken away by the user who therefore has the product on demand P of her choice in the bottle 2.

Said device comprises, for example, a dispenser in the form of a cabinet or a large housing 4. Said housing comprises a dispensing chamber 6, preferably freely accessible from the outside. For this, said chamber 6 here has a face 8 open to the outside at one 10 of the walls of the housing 4, in particular a facade of said housing. In other words, said dispensing chamber 6 opens to the outside.

Said dispensing chamber 6 is designed to accommodate said bottle 2. In this sense, it comprises a support 12, configured to accommodate the bottle 2 during the dispensing of the product on demand P.

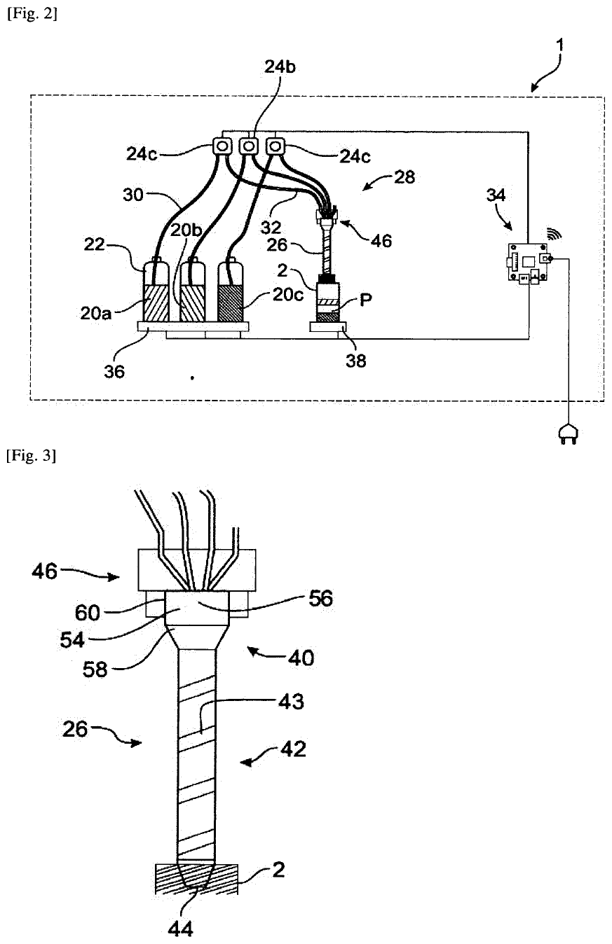

As illustrated in FIG. 2, according to the disclosure, said device is configured to allow a mixture of at least two products 20a, 20b, 20c, called base products, in proportions chosen from information coming from the user to form said on-demand product P.

Said base products may be any type of fluid and/or powdered products. These are, for example, products intended to be included in the composition of a cosmetic product. These are more particularly, among others, monochromatic products, namely, a mixture of a fluid base and a coloured pigment.

Here, only three base products are illustrated but the dispensing device according to the disclosure may equally allow the mixing of numerous base products, in particular several monochromatic products of different colours, one or more base products allowing the perfuming of said product on request, using one or more fragrances, and/or one or more texturising base products, giving it a particular appearance, in particular a glittery appearance. Said monochromatic products are, for example, eight in number. They preferably contain an identical base from one monochromatic product to another.

To combine a choice of colour and the presence or absence of a texturing effect, said base products advantageously comprise a plurality of monochromatics accompanied by a texturing base product and a base product, called neutral. Said texturing base product comprises a fluid base, possibly identical to that of the monochromatics, and a texturing component, for example glitter. Said neutral base product comprises only said fluid base. In addition, said device is configured so that each new dose of product on demand P comprises either a proportion of texturising base product, if the product on demand P ought to contain a texturising component according to the user's choices, or the same proportion of neutral base product if the product on demand P ought not to contain a texturising component according to the user's choices. Such a configuration makes it possible to maintain the same overall proportion of monochromatics in each dose and therefore to better control a rendering in terms of colour of the product on demand P from one dose to another, whether the user wishes the dose of said product on demand P dispensed to include a texturising component or not.

Said device further comprises, for example, a plurality of tanks or cartridges 22 intended to each contain one of said base products 20a, 20b, 20c. Said cartridges 22 are arranged, for example, in the lower part of the housing 4 though this location is not limiting.

Said cartridges 22 are, in particular, open to the open air, when in use. As a variant, they may be cartridges comprising an air intake system so as to be able to remain closed in use. As a further variant, they may comprise a deformable receptacle containing the base products so as to allow the base products to be collected without air intake, with the receptacle deforming as the base products are collected.

Said device further comprises a plurality of pumps 24a, 24b, 24c for collecting said base products from the cartridges 22, in said proportions. In other words, each of said cartridges 22 is associated with one of said pumps 24a, 24b, 24c so that one and only one of said pumps 24a, 24b, 24c is used to collect one and only one of said base products 20a, 20b, 20c. They are, for example, of the peristaltic type, which makes it possible to prevent the base products from coming into contact with moving parts.

According to the disclosure, said device comprises a mixer 26, configured to ensure the mixing of said base products 20a, 20b, 20c. Said device is further configured to supply said mixer 26 separately with said base products 20a, 20b, 20c, in said proportions, and to deliver the product on demand P at the outlet of said mixer 26. Said mixer 26 is preferably single-use.

“Single-use” means that the mixer 26 is intended to be changed with each new use, i.e., with each dispensing of a new dose of on-demand product P. “Separately” means that the device is configured so that there is no mixing of the base products 20a, 20b, 20c upstream of the mixer 26, even if they can enter said mixer 26 simultaneously, from a temporal viewpoint.

Thanks to the disclosure, said base products 20a, 20b, 20c are therefore not mixed upstream of the mixer 26 and the latter can be completely changed with each new use. This makes it possible to avoid the presence of residues from a previous dose when distributing the next dose, which could be detrimental to the appearance and/or the correct quantity of product on demand P dispensed.

Said device comprises, for example, a circuit 28 connecting the cartridges 22 to the mixer 26 through the pumps 24a, 24b, 24c. Said circuit 28 comprises, in particular, hoses, each of said hoses comprising a first part 30 connecting the cartridges 22 and the pumps 24a, 24b, 24c and a second part 32 connecting the pumps 24a, 24b, 24c and the mixer 26. Said first and second parts 30, 32 are in continuity with each other so that said hoses pass through said pumps 24a, 24b, 24c respectively. As will have been understood, said circuit 28 is subdivided into as many branches as there are base products, said branches separately supplying said mixer 26.

Said device further comprises an electronic control unit 34 for controlling the pumps 24a, 24b, 24c. Said pumps 24a, 24b, 24c therefore supply said mixer 26 with said base products 20a, 20b, 20c, in said proportions allowing the dispensing of the desired product on demand P.

Said control unit 34 comprises, for example, a memory unit, a processor and/or a communication interface. Said memory unit comprises a database making it possible to associate information relating to an product on demand P to be dispensed with the respective proportions and/or quantities of base products to be mixed in order to obtain said product on demand P. Said communication interface is configured to receive said information relating to the product on demand P to be dispensed. Said processor is configured to receive and exploit said information relating to the product on demand P to be dispensed, in order to determine with the aid of said database the respective proportions and/or quantities of base products to be mixed to obtain said product on demand P. Said processor is further configured to activate the pumps 24a, 24b, 24c correlatively so that said respective proportions and/or quantities of base products 20a, 20b, 20c to be mixed to obtain said product on demand P are collected from the cartridges 22.

To control the collection of said base products 20a, 20b, 20c, said device advantageously comprises first scales 36 for weighing the contents of each cartridge 22 respectively. Said first scales 36 make it possible to ensure the collection of the respective proportions and/or quantities of base products to be mixed to obtain said product on demand P.

Said device further comprises a second scale 38 for weighing the contents of the bottle 2. It makes it possible to ensure that the expected dose is fully dispensed while preventing too much product on demand P from being introduced into said bottle 2 and causing the product to overflow.

Said control unit 34 is configured to use data from the first scales 36 and the second scale 38 to control the pumps 24a, 24b, 24c until said product on demand P is delivered, after collecting said base products 20a, 20b, 20c in said proportions. Advantageously, said control unit 34 is configured so that the circuit 28 is filled with base products in each of the branches of the circuit 28, up to the mixer 26, after each dispensing of a dose of product on demand, so as to avoid any dead volume which could distort the dosage.

As illustrated in FIG. 3, the mixer 26 is preferably a static mixer. It therefore has the advantage of allowing a mixing of the base products without using moving parts, which would not be easily compatible and which would not be economically viable with the use of an interchangeable mixer for each use. The mixer 26 comprises, for example, a connection interface 40 and a mixing body 42. Said mixing body 42 is, in particular, tubular. Here it comprises an endless screw 43 for mixing. Said tubular body 42 has at its outlet a port 44 through which said product on demand P is intended to be dispensed into the bottle 2.

Said mixer 26 can, for example, be cleaned so it can be used again, after washing. It is however well understood that such cleaning does not occur at the level of said device but at the level of independent cleaning facilities so that, even if it can be cleaned, it must be changed on each use. Conversely, said mixer 26 may be disposable.

Preferably, said device further comprises an injector 46, configured to supply the mixer 26 with said base products 20a, 20b, 20c.

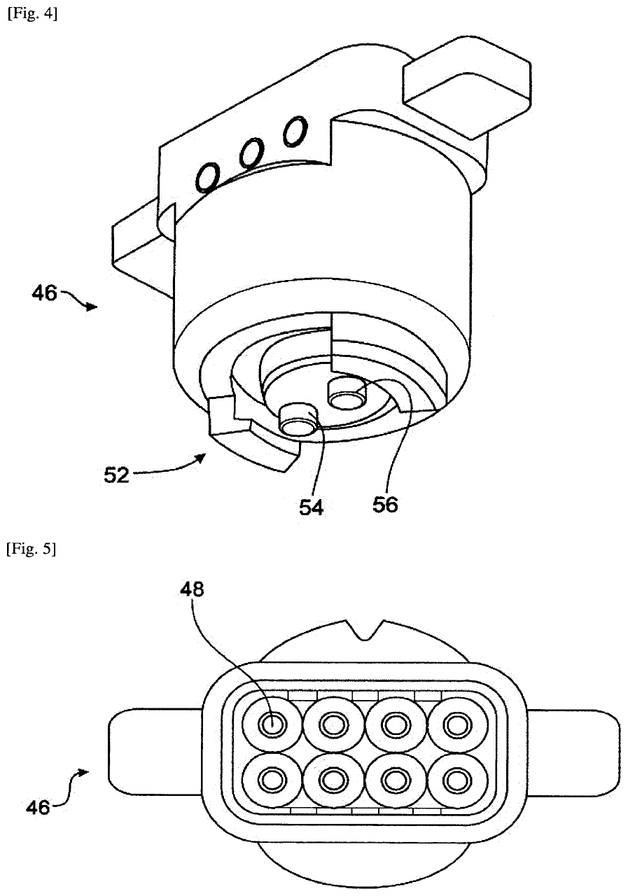

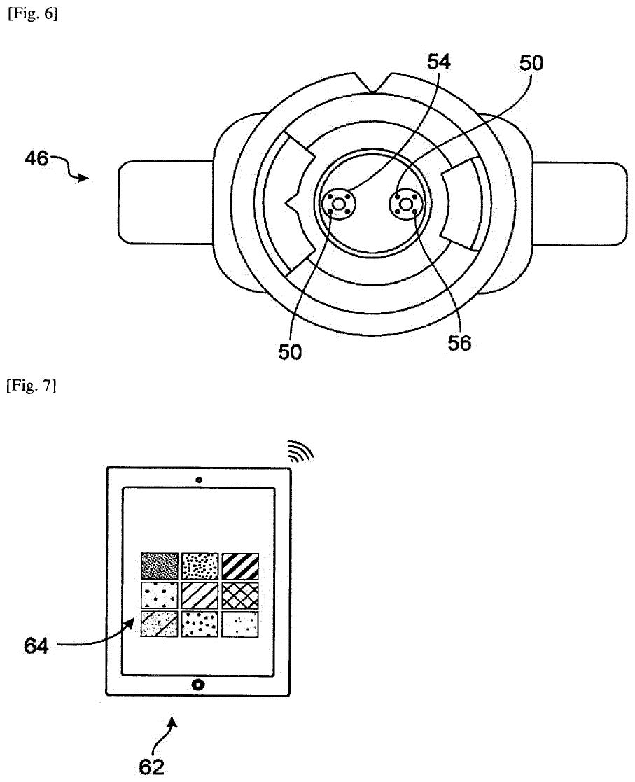

As is more obvious from FIGS. 4 to 6, the injector 46 comprises an inlet opening 48 and an outlet opening 50 for each of said base products 22a, 22b, 22c. Here, the injector 46 has been shown with eight inlet openings and eight outlet openings and corresponds to an injector of a dispensing device using eight base products and having as many branches in its circuit 28.

The inlet 48 and outlet openings 50 of the injector 46 are respectively connected by tubes for the circulation of the base products, said tubes not being visible because they are located internally in said injector 46. The tubes have a reduced cross-section between the inlet and the outlet. For example, a diameter of said inlet openings 48 is of the order of a millimetre while a diameter of said outlet openings 50 is smaller and of the order of a few tenths of a millimetre. As will be explained below, this makes it possible to group said outlet openings 50. Said inlet openings 48 are located, for example, at an upper surface of the injector. Here they are distributed in two rows.

Said injector 46 has an output interface 52 designed to cooperate with said connection interface 40 of the mixer 26 to be connected to each other.

Said outlet interface 52 has at least two pins 54, 56, one 54 of said pins having at least one of the outlets of the injector and the other or another of said pins having at least the other or another of the outlets of the injector; Here, the pins are two in number and each group together four output openings 50, in particular distributed at the top of a square.

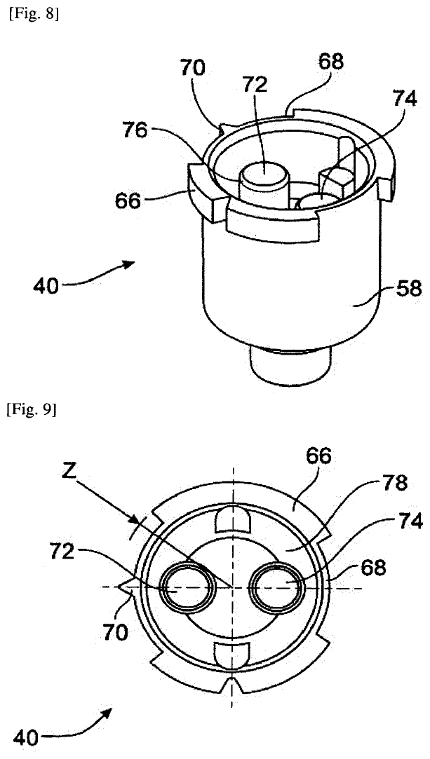

As described in FIGS. 8 and 9, said connection interface 40 has at least two cavities 72, 74. Each of the cavities 72, 74 is configured to accommodate respectively one of said pins 54, 56, so that said base products travel, here axially, into said cavities. A sleeve 76 forming an outline for each of said cavities 72, 74 is intended to laterally match up with said pins 54, 56 from the outside to form a sealed contact. Said cavities 72, 74 are in communication with the mixing body 42. In this way, said base products flow from the injector 46 to the mixing body 42 where they mix with each other before exiting through the port 44.

Preferably, said injector 46 and said mixer 26 are configured to allow a quick connection to each other, for example of the bayonet type. For this, said connection interface 40 here has an attaching skirt 58 and an internal part 78, housed in said skirt 58. The sleeves of said internal part 78 matches up laterally with said pins 54, 56. Said internal part 78 can be moved in rotation in said skirt 58 about a common longitudinal axis Z. Said skirt 58 and said outlet interface 52 have complementary shapes for guiding and fixing the mixer 26 on the injector 46.

Said complementary shapes comprise shoulders 60 extending angularly at the periphery of the outlet interface 52 and stops 66 extending angularly at a free edge 68 of the skirt 58. Said shoulders 60 are angularly spaced from one another so as to leave an axial passage for said stops 66, in a first positioning of the mixer 26 relative to the injector 46. In a second positioning of the mixer 26 relative to the injector 46, after axial passage of the stops 66 between the shoulders 60 and rotation of one of them relative to the other about their common longitudinal axis Z, the stops 66 are axially engaged on the shoulders 60.

A lug 70, located at the free edge 68, allows the mixer 26 to be angularly oriented relative to the injector 46 by cooperating with a slot provided in one of said shoulders 60 to allow the user to determine said first positioning.

When said mixer 26 is connected to the injector 46, the mixer 26 is brought into contact with said injector 46 in an axial translation movement, thanks to mutual guidance of said complementary shapes 60, 66. This translational movement causes the pins 54, 56 of the injector 46 to be inserted into the corresponding sleeves 76 of the mixer 26. In a second phase, said mixer 26 is rotated, for example by a quarter turn, about said common longitudinal axis Z, thanks to the mutual guidance, this time in rotation, of said complementary shapes 60, 66. During this second phase of the movement, said internal part rotates relative to the skirt 58, the latter being activated by the user and the internal part being immobilised by the introduction of the pins 54, 56 into the cavities 72, 74. At the end of this rotational movement, the mixer 26 is installed in the injector 46 and ready for use.

After use, it is removed in a reverse movement, in order to be able to install a new mixer for the dispensing of the next dose.

The disclosure also relates to a dispensing system comprising a device 1 as described above.

As illustrated in FIG. 7, said system further comprises a user interface 62, in relation to the control unit 34 and making it possible to determine the proportions of base products to be collected in order to obtain the product on demand P.

Said user interface 62 comprises, for example, a mobile digital medium such as a smartphone and/or a tablet, equipped with an application allowing a colour to be chosen for said product on demand P. Such an application allows for this purpose a display of a palette 64 of predefined colours corresponding to given proportions of base product.

According to a first embodiment, after selection of the colour desired by the user, information relating to the chosen colour is sent to the control unit 34, which, as already seen above, is configured to associate said information with given proportions of base products thanks to the database that said control unit 34 contains. As a variant, said database is included in said mobile digital medium. It is then directly the information relating to the proportions of each of the base products to be used which is sent by the mobile digital medium to said control unit 34.

Said mobile digital medium is equipped with remote communication means, in particular by wireless communication protocols such as those known as WiFi and/or Bluetooth, to send the information on the product on demand P to be dispensed to the connection interface of the control unit 34.

If we refer again to FIG. 1, we see that said dispensing chamber 6 allows the bottle 2 to be installed at the outlet of the mixer 26, for example at the level of the second scale 38. Preferably, said chamber 6 accommodates said mixer 26 so that said mixer 26 can be installed and removed at said chamber 6. It is therefore easily accessible and can be changed, on each dose, without having to access a closed part of the housing 4. Even more preferably, said injector 46 is flush with said chamber 6 so that said mixer 26 can be installed and removed from said injector 46 at said chamber 6 and without having access to a closed part of the housing 4.

Said injector 46 may be an interchangeable part although at a much lower frequency than that of the mixer 26, for maintenance reasons. To access said injector 26 for the purpose of replacing it, it may be necessary to have access to a closed part of said housing 4.

The disclosure also relates to a method for dispensing a fluid product on demand P, in particular a cosmetic product. Said method may be implemented using the device and/or system previously described.

Said method comprising a step of mixing at least two products 20a, 20b, 20c, called base products, in proportions chosen from information coming from a user to form said product on demand P.

According to the disclosure, said mixing step is carried out using a mixer 46 by supplying said mixer 26 separately with said base products 20a, 20b, 20c, in said proportions, and to deliver the product on demand P at the outlet of said mixer 26. In addition, said method comprises a step of installing a new mixer 26 for each new use, that is to say for each new command from a user and/or for each new dose dispensed.

Advantageously, said method comprises an initial step of filling a supply circuit 28 of the mixer 26.

Still advantageously, said method comprises a first step of weighing the base products 20a, 20b, 20c collected to form said fluid on demand. Said device comprises a second step of weighing the fluid on demand P dispensed into the bottle 2. Said first and second weighing steps are carried out simultaneously and throughout dispensing so as to control the dose of product on demand P dispensed.

1. A device for dispensing a fluid product on demand (P), in particular a cosmetic product, the device being configured to allow a mixture of at least two products, called base products, in proportions chosen from information coming from a user in order to form the product on demand, the device comprising a mixer, configured to ensure the mixing of the base products, the device being configured to supply the mixer separately with the base products, in the proportions, and to deliver the product on demand (P) at an outlet of the mixer, the mixer being single-use.

2. The device according to claim 1, wherein the mixer is a static mixer.

3. The device according to claim 1, further comprising an injector, configured to supply the mixer with the base products.

4. The device according to claim 3, wherein the injector comprises an inlet opening and an outlet opening for each of the base products, the inlet and outlet openings being respectively connected by base product circulation tubes, the tubes having a reduced cross-section between the inlet and the outlet.

5. The device according to claim 4, wherein the injector and the mixer are configured to allow quick connection to each other.

6. The device according to claim 1, comprising a housing having a dispensing chamber allowing an installation of a bottle intended to receive the product on demand (P) at the outlet of the mixer, the chamber opening to the outside, the chamber accommodating the mixer so that the mixer can be installed and removed at the chamber.

7. The device according to claim 1, comprising an electronic control unit, the control unit being configured to exploit data from scales to control the dispensing of the product on demand (P).

8. The dispensing system comprising a device according to claim 1, and a user interface making it possible to determine the proportions of base products to be collected to obtain the product on demand (P).

9. A method for dispensing a fluid product on demand (P), in particular a cosmetic product, the method comprising a step of mixing at least two products, called base products, in proportions chosen from information from a user to form the product on demand (P), the mixing step being carried out using a mixer by supplying the mixer separately with the base products, in the proportions, and to deliver the product on demand (P) at the outlet of the mixer, the method comprising a step of installing a new mixer for each new use.

10. The method according to claim 9, comprising an initial step of filling a supply circuit of the mixer.

11. The device according to claim 2, further comprising an injector, configured to supply the mixer with the base products.

12. The device according to claim 3, wherein the injector and the mixer are configured to allow quick connection to each other.

13. The device according to claim 2, comprising a housing having a dispensing chamber allowing an installation of a bottle intended to receive the product on demand (P) at the outlet of the mixer, the chamber opening to the outside, the chamber accommodating the mixer so that the mixer can be installed and removed at the chamber.

14. The device according to claim 2, comprising an electronic control unit, the control unit being configured to exploit data from scales to control the dispensing of the product on demand (P).

15. The dispensing system comprising a device according to claim 2, and a user interface making it possible to determine the proportions of base products to be collected to obtain the product on demand (P).

16. The device according to claim 3, comprising a housing having a dispensing chamber allowing an installation of a bottle intended to receive the product on demand (P) at the outlet of the mixer, the chamber opening to the outside, the chamber accommodating the mixer so that the mixer can be installed and removed at the chamber.

17. The device according to claim 3, comprising an electronic control unit, the control unit being configured to exploit data from scales to control the dispensing of the product on demand (P).

18. The dispensing system comprising a device according to claim 3, and a user interface making it possible to determine the proportions of base products to be collected to obtain the product on demand (P).

19. The device according to claim 4, comprising a housing having a dispensing chamber allowing an installation of a bottle intended to receive the product on demand (P) at the outlet of the mixer, the chamber opening to the outside, the chamber accommodating the mixer so that the mixer can be installed and removed at the chamber.

20. The device according to claim 4, comprising an electronic control unit, the control unit being configured to exploit data from scales to control the dispensing of the product on demand (P).
